(19) United States
(12) Patent Application Publication
(10) Pub. No.: US 2006/0047761 A1
(43) Pub. Date: Mar. 2, 2006

(54) Mechanism to support transparent roaming between IMP service providers in wireless networks

(75) Inventors: Alan Kaplan, Princeton, NJ (US); John Buford, Lawrenceville, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 10/930,043

(22) Filed: Aug. 30, 2004

(51) Int. Cl. G06F 15/16

(52) U.S. Cl. 709/206

(57) ABSTRACT

The instant messaging and presence (IMP) protocol implementations are swapped in and out as a client application roams among various service provider networks. The IMP API, and hence the IMP application, remains unchanged. Moreover, the IMP application continues to operate seamlessly and transparently. When the client application roams and a service provider change is detected, the system signals to the new service provider a profile containing the old IMP session details. A new IMP implementation is swapped into the existing IMP application. The IMP implementation may be downloaded in real-time, or it may exist on a SIM card or an SD card, or other suitable memory device.

### BACKGROUND OF THE INVENTION

The present invention relates generally to instant messaging and presence (“IMP”) services. More particularly, the invention relates to a mechanism to permit roaming between different service providers, utilizing a dynamically bound protocol stack.

Many portable devices such as cellular telephones and personal digital assistants are now equipped with IMP capability. Using this capability, users can send text messages to other participating users and can publish presence information telling the user's IMP status (available, away, offline, et cetera). Using IMP, the user of a portable device can send short instant messages to individual persons or buddies and also to groups of multiple buddies.

Currently, one limitation of the IMP paradigm derives from the fact that there are numerous, potentially incompatible, IMP services. While the basic functionality of all these services is largely the same, the protocols used can differ. Thus the user of one IMP service is typically not able to send and receive messages, or chat, with persons who are on another IMP service. One proposed solution has been to provide an IMP application that has multiple IMP protocol stacks that are then selectively utilized depending on the capabilities of the party being communicated with. In essence, this solution embeds the capability to communicate with plural IMP systems and then routes messages to the appropriate protocol stack, as needed.

While the aforementioned solution addresses some of the compatibility problems that currently exist, that solution does not fully address the complications that arise when one or more of the parties to an IMP session is mobile. Mobility implies the possibility that a user may roam from one service provider domain to another. This can potentially occur while the user is engaged in an active chat session (with one buddy or with a group) or not. Thus, when a user roams from one service provider to another, his or her ability to participate in IMP sessions with buddies could be lost, if the second service provider does not support the same protocols as the first. This potential loss of messaging capability may occur at two levels. First, active, live or ongoing messaging sessions may be dropped. Second, the ability to establish new sessions with existing buddies may be lost, as well.

Mobility further complicates how the user's presence information is communicated. In this regard, roaming can potentially occur while the user's presence is in any allowed state (e.g., available, away, offline). Unfortunately, different protocols may support different allowed states. Thus, it is possible for a user to roam into a new domain where his current presence state (according to the previous domain) is not defined.

The present invention addresses these mobility problems by providing an IMP middleware that allows IMP protocol implementations to be dynamically swapped in and out as a client application roams among various service provider networks. As one protocol is swapped out for another, the system coordinates the storing and mapping of state variables (including presence state variables) so that presence information is properly communicated.

One benefit of the innovative solution is that the IMP application program interface (API) and the IMP application can remain unchanged and can operate seamlessly and transparently as users roam. As the client application roams and a service provider change is detected, the system signals to the new service provider a profile containing the old IMP session details. A new IMP implementation is swapped into the existing IMP application automatically, so that the user experiences seamless and transparent operation notwithstanding the fact that service providers have changed. The IMP implementation may be either downloaded in real time or it may be previously stored in a suitable memory such as on a SIM card or an SD card.

The architecture of the invention also supports important business advantages. Because protocol implementations are dynamically swapped in and out as needed, the system readily supports an important business architecture where the user may be billed a premium charge for the roaming capability. These additional roaming charges can be integrated into the billing structure associated with a cellular service provider, or they may be implemented at an IMP service provider tier. In one embodiment, the dynamic linking mechanism, whereby one protocol stack is swapped out for another, may be mediated by an account billing system. Thus users who have signed on for the premium service will have the dynamic linking capability turned on (for all services or for selected services, as specified in the user's contract)

### SUMMARY OF THE INVENTION

According to one aspect, the invention provides method to support roaming in instant messaging systems that uses dynamically swappable middleware components. A first middleware component is configured to support instant message communication through a first service provider. When the system detects user roaming from the first service provider to a second service provider, a second middleware component is dynamically swapped for the first middleware component. The second middleware component is configured to support instant message communication through said second service provider. In this way the session may be seamlessly transferred from one service provider to another.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an IMP application with associated IMP middleware;

FIG. 2 is a message flow collaboration diagram illustrating IMP communication between two users;

FIG. 3 is a block diagram illustrating the dynamic linking mechanism in an exemplary situation where one user roams from a first service provider to a second service provider;

FIG. 4 is a block diagram illustrating a gateway technique whereby communication between two users is maintained despite the roaming of one user; and

FIG. 5 is a similar block diagram illustrating that multiple service provider domains may be supported.

### DETAILED DESCRIPTION OF THE PREFERRED EMBODIMENTS

The following description of the preferred embodiment(s) is merely exemplary in nature and is in no way intended to limit the invention, its application, or uses.

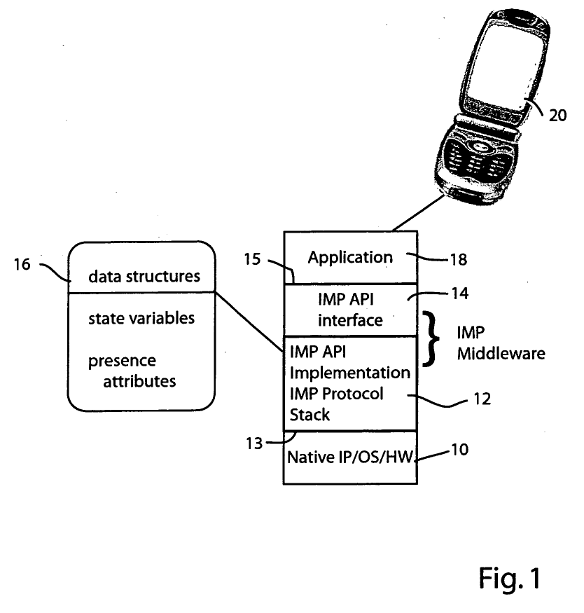

Referring to FIG. 1, a presently preferred architecture of the instant messaging application has been illustrated with the associated IMP middleware. Conceptually, the instant messaging and presence application can be viewed as comprising different layers of increasingly abstract functionality. Thus, at the lowest layer 10 are the hardware (HW) and operating system (OS), as well as basic support for a communication protocol such as the internet protocol (IP). Stacked above the lower layer 10 are the IMP middleware layers 12 and 14. Layer 12 provides the instant messaging and presence protocol stack as well as an instant messaging and presence application program interface (API) implementation.

Associated with the IMP API are the data structures 16 used by the IMP protocol stack during operation. These data structures include structures for storing state variables representing aspects of a live communication. The actual IMP application is then stacked upon layer 14 as at 18. The application represents that portion of the software with which the user interacts. The application may thus provide a text-based, graphical-based or audio/video-based interface on a suitable device such as the cellular telephone device illustrated at 20, or in a browser-based application running on a computer, or the like.

As will be more fully explained below, the present architecture is designed so that the application layer 18 does not need to change as the user migrates from one service provider domain to another. Instead, the IMP middleware layers are dynamically swapped out and replaced with a different IMP middleware collection corresponding to the protocols used by the service provider domain into which the user has migrated.

The IMP middleware layers may be configured as a middleware component, suitable for downloading from a host system such as a system associated with an instant messaging service provider. The middleware component includes a first interface 13 for dynamically linking to the operating system associated with an instant messaging appliance (or adapted to employ a library or module that directly uses operating system functions, as by making pre-linked or statically linked calls), and a second interface 15 for dynamically linking to the IMP application hosted by the operating system of the appliance. The middleware component thus can be dynamically connected to the operating system (by dynamic linking to the operating system, or by employing library or module that directly uses operating system functions as noted above) and to the corresponding IMP application and enabled to work in processing instant message and presence communication on the appliance. If desired the component can be configured to include a locking mechanism that inhibits the component from working unless a suitable key is provided.

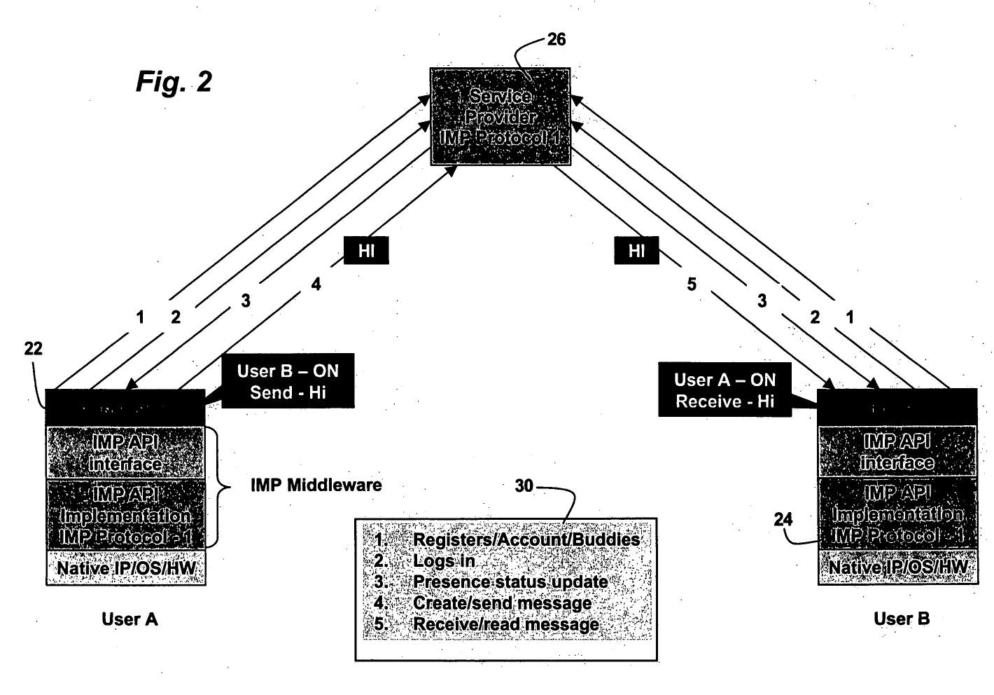

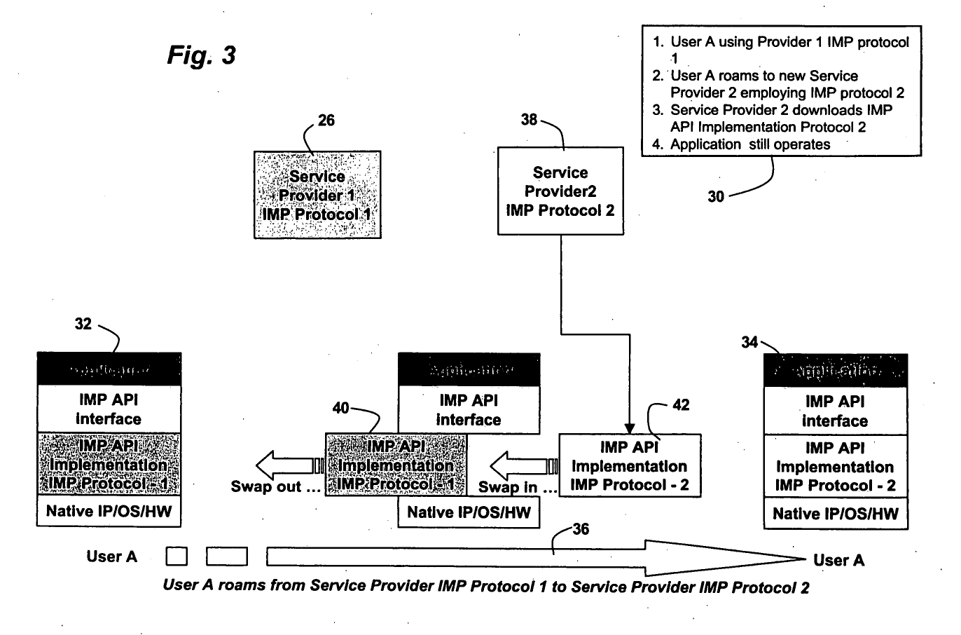

FIG. 3 illustrates the basic process. However, before discussing FIG. 3, reference will be made to FIG. 2, which shows how an instant messaging session might be set up and processed through a single service provider.

Referring to FIG. 2, the scenario assumes that user A and user B wish to communicate with one another. The instant messaging application of user A is shown at 22 while the instant messaging application of user B is shown at 24. In this scenario both users will communicate with each other through service provider 26. In this scenario service provider 26 uses IMP protocol 1.

The steps performed in order to establish and participate in a message communication have been listed in box 30. Each step is numbered and the numbers correspond to the directed lines (arrows) that link each user with service provider 26. Thus, the process begins with both users A and B registering their account and identifying their buddies. Each user then logs in (step 2) and then each user's presence status is updated (step 3). In this scenario, user A creates a message (step 4) and sends it to the service provider 26, which then forwards the message to user B (step 5).

The process illustrated in FIG. 2 represents a basic communication flow. In this scenario there has been no mobility. Each user communicates through the same service provider based on a single IMP protocol 1.

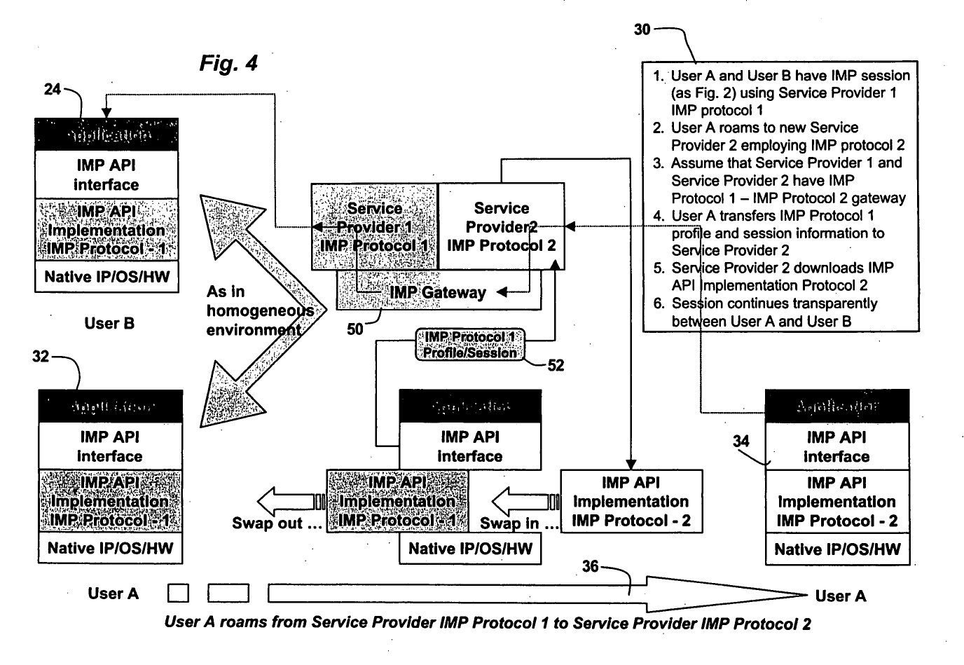

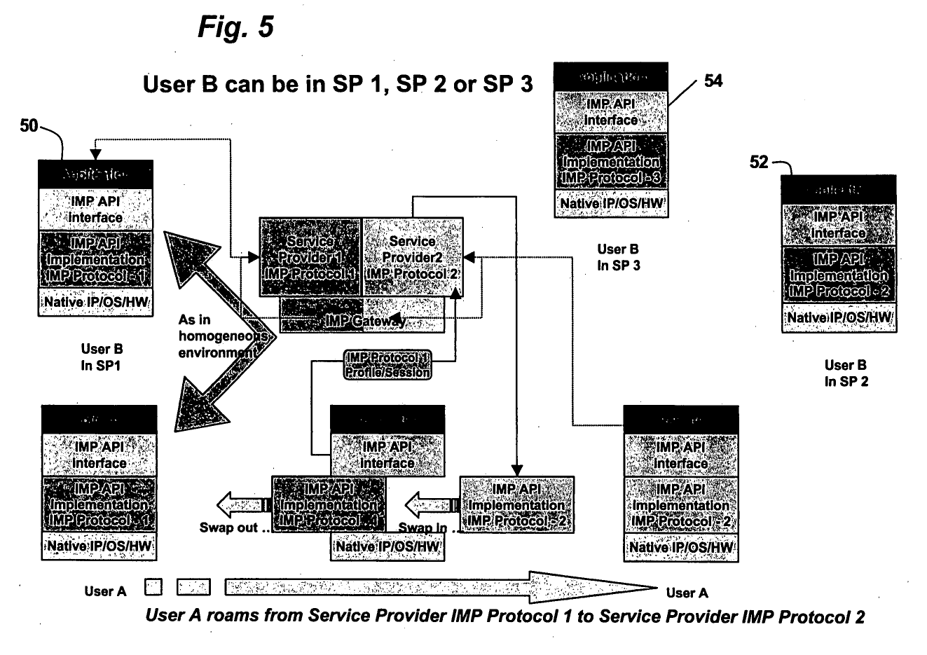

As shown in FIG. 3, the mechanism of the invention supports mobility for roaming. In FIG. 3 user A migrates from location 32 to location 34, as depicted by the mobility arrow 36. Note that user B is not illustrated in FIG. 3. Examples showing both user A and user B will be presented next in connection with FIGS. 4 and 5.

As the user roams from position 32 to position 34, it will be assumed that the user migrates from an area serviced by service provider 1 and moves into an area serviced by service provider 2. Service provider 1 is illustrated at 26 and service provider 2 is illustrated at 38. In this scenario service provider 2 uses an IMP protocol 2, which is different from the IMP protocol 1 used by service provider 1. The steps performed during migration from location 32 to location 34 have been illustrated in box 30. The procedure begins while user A is using service provider 1 (IMP protocol 1). Thus the user is using the IMP protocol stack 40 in FIG. 3. As depicted at step 2, the user then roams to a new service provider 2 (employing IMP protocol 2). Service provider 2 then downloads the IMP protocol 2 stack to the user's application so that the IMP protocol 2 stack 42 is swapped in as protocol 1 stack 40 is swapped out. Note that the application and IMP API interface layers remain unchanged, thus the user experience is a seamless one: the application works the same as before, it just uses a different protocol stack.

In swapping the IMP protocol stack in and out, several variations are possible. In one embodiment, the IMP protocol stack is downloaded, with the associated IMP application remaining unchanged. In another embodiment, the IMP application may also be included in the download. Thus the IMP application software can be changed dynamically, as well. In both cases, the downloaded software (IMP protocol stack and/or IMP application) may be pushed (e.g. automatically sent) to the user's instant messaging appliance by the service provider; or the downloaded software may be pulled from the service provider (e.g., download requested by the user's instant messaging appliance). Alternatively, the download location may be identified by a URI supplied by the service provider. This behavior could be pre-configured or dynamic.

As illustrated above, the techniques for swapping the IMP protocol stack can take many forms. We have adopted the term “dynamic swapping” as a name for this technique. It will be understood that such dynamic swapping can take a variety of different forms, depending on the particular technology used to implement the system. By way of non-limiting example, the following forms may be used to effect dynamic swapping:
associating a name with objects or implementations through a name binding operation;
locating a software component by its name or ID and associating a reference to it (such as through a method call) in another component—such process sometimes being referred to as “dynamic resolution;”
resolving a function or variable to its absolute or relative address, as by symbol resolution;
dynamically resolving bindings between software that uses a library or module to a library or module containing the implementation of the named functions, object, and/or variables—such process sometimes being referred to as “dynamic linking,” or “linking;”
reading a library or module from storage, to combine or couple it with an executing program—such process sometimes being referred to as “dynamic loading,” or “loading;”
reading a class file into memory and installing it as a class table where it can be used to instantiate instances or objects—such process sometimes being referred to as “class loading,” as in an object oriented programming system such as Java;
reconfiguring the operating system, such as by employing a modular operating system in which modules or components can be changed on the fly; and
performing memory management by moving pages or segments to and/or from secondary storage—such process sometimes being referred to as “swapping.”

The embodiments illustrated and discussed above show the old IMP stack being swapped out or replaced by a new stack. However, it is possible to construct a variation of these embodiments where the previous IMP stack is not necessarily deactivated. This would allow the client application to keep a copy of the previous IMP stack available for re-use, as needed at a later time.

When changing the IMP application the preferred embodiment preserves session state in an application independent way. This may be done by storing the application independent state variables in the data structures 16. When the new IMP application loads, it then retrieves this stored state information.

In some applications it may be more expedient to dynamically activate previously stored IMP software. In one such embodiment, the IMP software may be stored in a suitable memory associated with the instant messaging appliance, such as in flash memory plugged into the appliance. The stored software would then be activated and deactivated as the user roams. Activation may be effected by any of the means discussed above for pushing and pulling the IMP software to the appliance from the service provider, or from a cite referenced by URI supplied by the service provider. The IMP software may thus be pre-installed but require a “key” for running. The service provider would push the key to the appliance, as needed. The key could have an associated lifetime, license and/or billing contract. In this way the system readily supports business models where users may be charged different rates according to the roaming service capabilities they desire.

FIG. 4 shows how the instant messaging communication would flow between user A and user B as user roams from service provider 1 to service provider 2. In FIG. 4, user B is illustrated at 24. User A migrates from 32 to 34 as indicated by the mobility arrow 36. The steps performed in this scenario are outlined in box 30. In this scenario it is assumed that users A and B have an IMP session using service provider 1 (IMP protocol 1). User A roams to a new service provider 2 (employing IMP protocol 2). In this scenario service provider 1 and service provider 2 employ a protocol gateway 50 that passes messages from one provider to the other, performing any message translation that may be required to conform the two protocols.

User A then transfers the IMP protocol 1 profile and session information to service provider 2, as depicted by the message packet 52. Service provider 2 then downloads IMP API implementation protocol 2 to the user A. In this way the session may continue transparently between user A and user B.

In FIG. 4, roaming user A communicated with stationary user B. User B remained in the domain of service provider 1 throughout the series of interactions comprising the instant messaging session. However, it is equally possible for user A to communicate with stationary users in other domains as well. This is illustrated in FIG. 5. In FIG. 5, three examples of user B have been illustrated at 50, 52, and 54. At location 50, user B is in the domain of service provider 1. At location 52, user B is in the domain of service provider 2. In location 54 user B is in the domain of service provider 3. Note that in each case, user B employs the IMP protocol prescribed by his service provider. To support the connection with user B at 52, a gateway would be provided between service provider 1 and service provider 2. When user A migrates to the domain of service provider 2, the gateway would no longer be required, as users A and B would both be in the same service provider domain. Likewise, to support the connection with user B at 54, a gateway would be provided between service provider 1 and service provider 3.

The system supports a variety of different roaming variations. In one scenario the instant messaging session is active during transfer (i.e., during the time a user roams from one service provider domain to another). Under this scenario, two variations are possible. One, the session was started in the user's primary service provider domain. Two, the session was started in a service provider domain that the user roamed into prior to beginning the session. In another scenario, no instant messaging session is active, but presence subscriptions are in place. Thus as the user roams, his or her presence attributes are automatically updated. In a third scenario, multiple instant messaging sessions are active. That is, a user may have several active sessions running, with different buddies, when the transfer takes place. In a forth scenario, a group instant messaging session is active. In this scenario, multiple users are participating in a group chat, when one or more of the users migrate to different service provider domains.

As illustrated in FIG. 1, the API contains the data structures used by the IMP protocol stack and the data structures used to store state variables associated with any instant messaging session that happens to be active when roaming occurs (session variables) as well as the IMP profile variables associated with the user. When the new IMP protocol stack is swapped in, replacing the prior IMP protocol stack, the system automatically (dynamically) maps the API data structures so that the data stored therein will work properly with the new IMP protocol stack. The dynamic mapping procedures may be incorporated into any of the software layers illustrated in FIG. 1 and provide the capability to perform both syntactic mapping and semantic mapping. If stored in the IMP middleware layers, the swap in procedure would include a bootstrap routine whereby the data stored in data structures 16 are preserved temporarily while the new IMP stack protocols are loaded. Thereafter the temporarily stored data are mapped and loaded into the active data structures used by the new protocols. Thus the system is configured to automatically transfer the state variables, performing any necessary mapping of the variables from a first grammar associated with the first service provider to a second grammar associated with the second service provider.

Syntactic mapping involves a direct translation of primitive data types, such as translating an integer field (used by one protocol) to a floating point field (used by the other protocol). Semantic mapping involves mapping objects or classes in which there might not be a one-to-one correspondence of individual components. Thus semantic mapping would be performed where each IMP protocol stack would have an object corresponding to “Service Provider”:

| SP1 | SP2 |
|---|---|
| Protocol.Stack.registry | Protocol.Stack.authorization |
| Protocol.Stack.proxy | Protocol.Stack.leaseDate |
| Protocol.Stack.vendor | Protocol.Stack.vendorversion |
| Protocol.Stack.version | |

In the above table, some fields (e.g., first two rows) may not have a meaningful correspondence between the two stacks. In the latter two rows, vendor/version might be composite for SP2, but separate fields in SP1, as illustrated. The semantic mapping determines which fields are properly associated in such cases. In one preferred embodiment, the swap-in/swap-out procedure determines automatically whether to employ syntactic or semantic mapping, and how to effect the semantic mapping, base on the identity of the IMP stack being swapped out and the IMP stack being swapped in. Where the data are communicated using XML, the information needed to determine the syntactic and semantic requirements of each stack can be ascertained from the corresponding document type definition (DTD).

While there are many ways to implement the mechanisms to support transport roaming as described herein, one convenient approach is to construct an IMP middleware that provides abstract data types for instant messaging and presence services. The middleware may consist of an application programming interface (API), which may be separated into the API interface and the API implementation. Where the API implementation represents an implementation of a specific IMP protocol (e.g., SIP/SIMPLE, Wireless Village, XMPP, and the like), the API can be constructed using different implementations. However, the API interface can remain unchanged. The IMP middleware so constructed thus encapsulates information about the current IMP implementation (i.e., protocol) that is being employed by the IMP middleware. Each IMP middleware maintains the IMP profile and session information.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method to support roaming in instant messaging systems comprising:
employing a first middleware component configured to support instant message communication through a first service provider;
detecting user roaming from said first service provider to a second service provider;
in response to detecting user roaming, dynamically swapping a second middleware component for said first middleware component, the second middleware component being configured to support instant message communication through said second service provider.

2. The method of claim 1 wherein instant messaging system employs an instant messaging appliance having an operating system and wherein said step of dynamically swapping is performed by dynamically linking said second middleware component to said operating system.

3. The method of claim 1 wherein instant messaging system employs an instant messaging appliance having an operating system and an instant messaging application hosted by said operating system and wherein said step of dynamically swapping is performed by dynamically linking said second middleware component between said operating system and said instant messaging application.

4. The method of claim 1 wherein said step of dynamically swapping is performed by enabling said second middleware component and disabling said first middleware component.

5. The method of claim 1 wherein said step of dynamically swapping is initiated by a system associated with said second service provider.

6. The method of claim 1 wherein said step of dynamically swapping is initiated by an instant messaging appliance and responded to by a system associated with said second service provider.

7. The method of claim 1 wherein said step of dynamic swapping includes the step of using a key to unlock said second middleware component.

8. The method of claim 1 wherein said step of dynamic swapping includes the step of sending a key from a system associated with said second service provider and using said key to unlock said second middleware component.

9. The method of claim 7 further comprising defining a contractual relationship between user and at least one of said service providers and tying use of said key to unlock said second middleware component to the terms of said contractual relationship.

10. The method of claim 1 further comprising maintaining a data store of state variables associated with said instant messaging communication through said first service provider and in response to detecting user roaming automatically transferring said state variables to at least one data structure associated with said second middleware component.

11. The method of claim 10 wherein said step of automatically transferring said state variables includes the step of performing mapping of said variables from a first grammar associated with said first service provider to a second grammar associated with said second service provider.

12. The method of claim 11 wherein said mapping step includes a syntactic mapping.

13. The method of claim 11 wherein said mapping step includes a semantic mapping.

14. The method of claim 1 further comprising maintaining a data store of state variables associated with user presence mediated by said first service provider and in response to detecting user roaming automatically transferring said state variables to a data store associated with said second service provider.

15. The method of claim 1 further comprising processing said instant message communication through a gateway that routes said instant message between said first and second service providers and performs protocol conversion upon said instant message to render said instant message compatible with both service providers.

16. A mechanism to support roaming between instant messaging service providers comprising:
a memory associated with an instant messaging appliance and configured to store an instant messaging middleware component;
said middleware component having a first interface for dynamically linking to an operating system associated with said instant messaging appliance;
said middleware component having a second interface for dynamically linking to an instant messaging application run on said instant messaging appliance.

17. The mechanism of claim 16 further comprising data structure associated with said middleware component, said data structure being configured to store state variables associated with an instant messaging service.

18. The mechanism of claim 16 wherein said middleware component is configured as a downloadable component.

19. The mechanism of claim 16 wherein said middleware component includes an instant messaging and presence protocol stack.

20. The mechanism of claim 16 wherein said middleware component includes a lock mechanism that inhibits use of said middleware component unless an associated key is supplied.
